(19) United States
(12) Patent Application Publication
(10) Pub. No.: US 2006/0131857 A1
(43) Pub. Date: Jun. 22, 2006

(54) Gas bag module with a discharge opening

(75) Inventors: Helga Heist, Laufach (DE); Martin Kreuzer, Kleinwallstadt (DE); Markus Keutz, Rossdorf (DE); Michael Lehmann, Aschaffenburg (DE); Joachim Fellhauer, Nilkheim (DE); Lutz Haese, Aschaffenburg (DE); Michael Schneider, Sulzbach (DE); Michael Deckenhoff, Duelmen (DE); Matthias Helmstetter, Aschaffenburg (DE); Klaus Freudenberger, Aschaffenburg (DE); Thomas Britz, Bessenbach (DE); Marcus Magoley, Aschaffenburg (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/302,010

(22) Filed: Dec. 13, 2005

(30) Foreign Application Priority Data
Dec. 16, 2004 (DE) 20 2004 019 447.3

(51) Int. Cl. B60R 21/26; B60R 21/239

(52) U.S. Cl. 280/740; 280/742; 280/743.1

(57) ABSTRACT

A gas bag module for a vehicle occupant restraint device includes a rigid component (16). The rigid component (16) has a discharge opening (14) formed therein through which gas can escape. A control element (10) is arranged at the discharge opening (14). The control element (10) assumes a rolled-up state in the case of low pressure action and assumes an unrolled state in the case of greater pressure action.

### TECHNICAL FIELD

The invention relates to a gas bag module for a vehicle occupant restraint device, in particular to a gas bag module with a discharge opening through which gas can escape.

### BACKGROUND OF THE INVENTION

Basically, in a gas bag module, the gas bag is to be filled as quickly as possible with the gas generated by the gas generator. In particular cases it is, in fact, desirable to adapt the quantity of gas or the internal pressure in the gas bag to particular conditions. For this purpose, discharge openings which are able to be freed can be provided in the gas bag itself or in rigid components of the gas bag module.

From US 2004/0 051 285 A1 a gas bag module is known with valve flaps which can close or free discharge openings formed in a gas generator carrier. The valve flaps are connected by limiting straps to a part of the gas bag fabric facing the vehicle occupant. On activation of the gas bag module, the valve flaps are initially in the open position, so that gas can escape. If the unfolding gas bag comes into contact very early with the vehicle occupant, the discharge openings remain open. Thereby, the pressure of the unfolding gas bag and hence the force exerted onto the vehicle occupant is reduced. If, on the other hand, the vehicle occupant is in a position which is further away from the gas bag module, the discharge openings are closed in the course of the further unfolding by the limiting straps, against the internal pressure of the gas bag, so that no more gas can flow off. US 2004/0 051 285 A1 also mentions another design, according to which the valve flaps are initially closed and only open with increasing internal pressure of the gas bag.

It is an object of the invention to provide a gas bag module with a discharge opening, the effective cross-section of which regulates itself by simple means.

### BRIEF SUMMARY OF THE INVENTION

The gas bag module for a vehicle occupant restraint device according to the invention includes a rigid component. The rigid component has a discharge opening formed therein through which gas can flow off. A control element is arranged at the discharge opening. The control element assumes a rolled up state in the case of a low pressure action and an unrolled state in the case of a higher pressure action.

The control element provided according to the invention makes possible in a simple manner an automatic adaptation of the out-flowing quantity of gas as a function of the internal pressure prevailing in the gas bag.

Preferably, the control element is constructed so that it rolls up automatically through elastic force.

The control element can comprise a tube-like body in the manner of a “party tooter”, which unrolls by the blowing in of gas with a particular minimum pressure.

According to a first embodiment of the invention, the effective discharge cross-section is to increase with rising internal pressure of the gas bag. This can be achieved through the arrangement of the tube-like body with one end at the edge of the discharge opening.

According to a second embodiment of the invention, the effective discharge cross-section is to reduce with rising internal pressure of the gas bag. This can be achieved in that the control element is arranged next to the discharge opening so that in the unrolled state it at least provides for a partial covering of the discharge opening.

### BRIEF DESCRIPTION OF THE DRAWINGS

FIG. 1 shows a retraction element for a gas bag module according to the invention;

FIG. 2 shows a first embodiment of the invention; and

FIG. 3 shows a second embodiment of the invention.

### DETAILED DESCRIPTION OF THE PREFERRED EMBODIMENTS

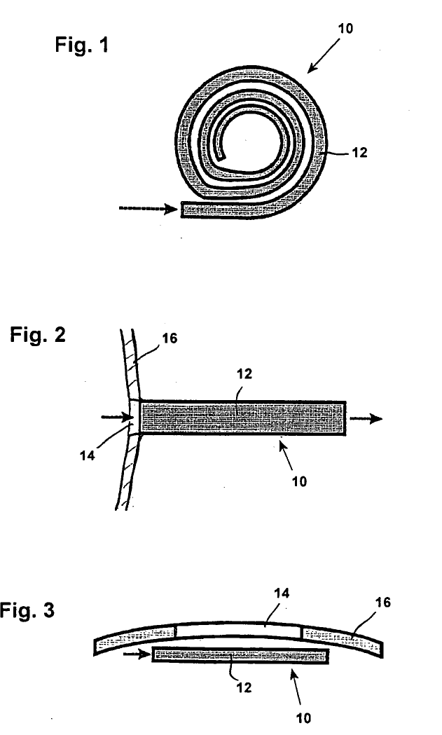

FIG. 1 shows a control element 10 which is comparable with a “party tooter” in its manner of functioning. The control element 10 consists substantially of a tube-like body 12 which is open at both ends. The control element 10 rolls itself up in a spiral shape automatically through elastic force, so that in normal state, i.e. without a particular action of pressure, it assumes the shape shown in FIG. 1.

By blowing in air (or another gas) with a particular minimum pressure, the control element unrolls itself and assumes the elongated shape shown in FIGS. 2 and 3. At lower pressure, at least a portion of the control element remains in the rolled-up state and no gas at all, or only a little gas, can flow through the control element 10.

In FIG. 2 a first embodiment of the invention is illustrated. The control element 10, which is shown here in the unrolled state, is arranged with one end of the tube-like body 12 at the edge of a discharge opening 14. The discharge opening 14 itself is formed in a rigid component 16 of a gas bag module (which is not illustrated in further detail), e.g. in a gas generator carrier or in a wall of a module housing. On exceeding a predetermined internal pressure of the gas bag, which can occur under particular circumstances, the control element 10 unrolls and gas can escape through the tube-like body 12.

If, at a later time, the pressure falls below the critical value again, the control element rolls up again so that the discharge process is stopped again. Thereby, the effective cross-section of the discharge opening 14 adjusts itself automatically as a function of the internal pressure of the gas bag.

Exactly the reverse effect is achieved with the embodiment illustrated in FIG. 3. Here, the control element 10 is arranged on the inner side adjacent to the discharge opening 14 so that in the rolled-up state of the control element 10, the discharge opening 14 is freed. The exterior end of the tube-like body 12 in the rolled-up state faces the inflowing gas, so that the control element 10 unrolls at higher pressure and at least partially closes the discharge opening 14 directly or indirectly, as shown in FIG. 3.

In both embodiments, the discharge behaviour can be influenced in particular through the selection of the cross-section of the tube-like body 12 of the control element 10, which can also taper from one end to the other.

1. A gas bag module for a vehicle occupant restraint device, the gas bag module including a rigid component having a discharge opening formed therein through which gas can escape, a control element being arranged at the discharge opening, the control element assuming a rolled-up state in the case of low pressure action and assuming an unrolled state in the case of greater pressure action.

2. The gas bag module according to claim 1, wherein the control element rolls up automatically through elastic force.

3. The gas bag module according to claim 1, wherein the control element comprises a tube-like body which unrolls through the blowing in of gas with a particular minimum pressure.

4. The gas bag module according to claim 3, wherein the tube-like body is arranged with one end at the edge of the discharge opening.

5. The gas bag module according to claim 1, wherein the control element is arranged next to the discharge opening so that in the unrolled state it provides at least for a partial covering of the discharge opening.
